(19) United States
(12) Patent Application Publication
(10) Pub. No.: US 2026/0174530 A1
(43) Pub. Date: Jun. 25, 2026

(54) DENTAL IMPRESSION DIGITAL SCALING FACTOR SYSTEM AND METHOD

(71) Applicant: National Dentex, LLC, Palm Beach Gardens, FL (US)

(72) Inventor: Christopher Halke, Palm Beach Gardens, FL (US)

(73) Assignee: National Dentex, LLC, Palm Beach Gardens, FL (US)

(21) Appl. No.: 18/988,749

(22) Filed: Dec. 19, 2024

(51) Int. Cl. A61C 9/00

(52) U.S. Cl. CPC A61C 9/0073

(57) ABSTRACT

A model generator generates an impression scan by scanning a polyvinyl impression and generates a stone model using the polyvinyl impression as a negative mold. A comparative analysis of the impression scan and a scan of the stone model determines a digital scaling factor that scales the impression scan to align with the stone model scan. A scan alteration system receives impression scans for dental component production processing and selects digital scaling factors generated by the model generator that scale the impression scans to align with theoretical stone model scans that would be produced by an applicable modeling and scanning process to generate a scaled surface model for use in dental component production.

### TECHNOLOGY

The present application is directed to scaling of scans of dental impressions to generate scaled digital surface models for use in production of dental components.

### BACKGROUND

A negative impression of a patient's intraoral environment may be obtained by injecting an impression material such as polyvinyl onto a tray which is then inserted into the patient's mouth to receive the imprint. A single tray impression is a type of impression in which a plastic frame containing a handle on some portion of the tray is injected with polyvinyl and inserted into the patient's mouth to capture either the maxillary or mandibular jaw. This style of tray captures a single jaw, and cannot capture the bite relationship. A triple tray impression is a type of impression in which a plastic frame containing a mesh and having a handle on some portion of the frame is injected with polyvinyl and inserted into the patient's mouth to capture a record of the maxillary and mandibular jaw simultaneously as well as the bite relationship between those two jaw halves. The frames include quadrant, capturing 25% or less of the mouth, and anterior, capturing the front teeth of the jaw, varieties.

Dental stone models of the intraoral environment may be made from the impression by pouring dental stone material into the negative impression and allowing the dental stone material to cure, thereby creating a representative model of the intraoral environment. Dental stone models are used by dental professionals for purposes of diagnosis and planning treatments. Dental stone models are also used by producers of dental appliances as references to fabricate dentures, retainers, crowns, bridges, and other dental materials and components.

Polyvinyl impression material shrinks during the curing process. Thus, the impression is not an accurate replication of the patient's actual intraoral environment. Dental stone expands during the curing process. The specific expansion factors vary per brand and type of dental stone. Within the dental lab industry, it is accepted that shrinkage of polyvinyl impressions is offset by the expansion of the dental stone material.

### SUMMARY

In one aspect, a digital scaling factor system is configured to determine an impression scan digital scaling factor and scale impression scans to generate scaled surface models for use in dental component production. The system may include a model generator including a scan capture unit configured to scan a polyvinyl impression using a type of scan capture system and a stone modeling unit configured to generate a stone model using the polyvinyl impression as a negative mold. The scan capture unit may be configured to scan the stone model after curing using a same type of scan capture system used to scan the impression. The system may include a comparison module configured to perform a comparative analysis of the impression scan and stone model scan and determine a digital scaling factor that scales the impression scan to align with the stone model scan. The system may include a scan alteration system configured to receive an impression scan for scaling that was generated from a polyvinyl impression. The scan alteration system may be further configured to select a digital scaling factor that would align the impression scan for scaling with a stone model scan of a stone model that would be generated from the polyvinyl impression that was scanned to generate the impression scan for scaling if utilizing an identified type of scan capture system and stone modeling process. The scan alteration system may include a scan alteration generator including a digital scaling factor processor configured to scale the impression scan for scaling by the selected digital scaling factor to generate a scaled surface model.

In one example, the impression scan for scaling is associated with an impression source.

In a further example, the scan alteration system is configured to receive a production facility identifier with the impression scan for scaling and use the impression source and production facility identifier to identify the digital scaling factor that scales the impression scan to dimensions of the stone model that would be generated from the impression using scanning and stone modeling processes of the production facility.

In one example, the scan alteration system further includes a scan capture unit and is configured to use the scan capture unit to scan polyvinyl impressions for scaling of impression scans generated from the polyvinyl impressions for scaling. The scan alteration generator may be configured to select a digital scaling factor that would align the impression scan of the polyvinyl impression for scaling with a stone model scan of a stone model generated using the polyvinyl impression for scaling as a negative mold if utilizing an identified type of scan capture system and stone modeling process. The digital scaling factor processor may be configured to scale the impression scan of the polyvinyl impression for scaling by the selected digital scaling factor to generate a scaled surface model.

In one example, the model generator is configured to select multiple single tray full arch polyvinyl impressions and scan the impressions, generate stone models from the impressions, and scan the stone models.

In one example, the comparison module comprises a comparison report generator and a scaling unit. The comparison report generator may be configured to compare the impression scan and stone model scan and output a comparison report depicting misalignment between the impression scan and the stone model scan. The scaling unit may be configured to interpret the comparison report and scale the impression to align with the stone model scan.

In a further example, the scaling unit is configured to interpret the comparison report to determine direction the impression scan should be scaled to align with stone model scan.

In a further example, the comparison report includes a heat map that depicts the misalignment.

In a further example, the scaling unit is configured to apply an incremental scaling adjustment to the impression scan and the comparison report generator is configured to perform the comparative analysis after each incremental adjustment until the comparison report generator generates a comparison report that indicates alignment between the scaled impression scan and stone model scan.

In a further example, the scaling unit is configured to determine a direction of scaling adjustment based on the interpretation of the comparison report. The scaling unit may be configured to apply an incremental scale adjustment to the impression scan in the direction followed by comparative analysis by the comparison report generator after each incremental scale adjustment until a comparison report indicates alignment or overshot. If the comparison report indicates overshot, the scaling unit and comparison generator may be configured to iteratively repeat application of an incremental scale adjustment, reduced relative to the incremental scale adjustment previously applied that resulted in the overshot, to the impression scan in a direction opposite of the previous direction that resulted in the overshot, and perform comparative analysis until a comparison report indicates alignment.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 illustrates a digital scaling factor system for generating and applying a digital scaling factor according to various embodiments described herein;

FIG. 2 illustrates a digital scaling factor determination and alteration method for scaling impression scans for use in production of dental components according to various embodiments described herein;

FIG. 3 illustrates a method for generating impression and stone model scans for importation into a comparison system according to various embodiments described herein;

FIG. 4A illustrates a method of generating a digital scaling factor from impression scans and stone model scans of stone models molded from impressions corresponding to the impression scans according to various embodiments described herein;

FIG. 4B illustrates a method of determining a digital scaling factor that scales the impression scan to align with the stone model scan according to various embodiments described herein;

FIG. 4C illustrates a method of iterative incremental adjustment of a scale of an impression scan followed by comparative analysis to align the scaled impression scan with a stone model scan according to various embodiments described herein;

FIG. 5 schematically illustrates a comparison system for generating a digital scaling factor according to various embodiments described herein;

FIG. 6 schematically illustrates a scan alteration system for scaling impression scans by applying a digital scaling factor for use in production of dental components; and

FIG. 7 is a schematic diagram of a machine in the form of a computer system within which a set of instructions, when executed, may cause the machine to perform prediction, recommendation, and attribution operations of the demand generation system according to various embodiments described herein.

### DESCRIPTION

Due to shrinkage during the curing process, information represented in a polyvinyl dental impression is smaller than a patient's actual intraoral environment. While expansion of dental stone material used to create a dental stone model from the impression is accepted to offset the shrinkage, the difference in expansion across brands of dental stone material being used suggests that this is a generalization rather than an exact offset of the properties of the two materials. Indeed, our research strongly suggests that while the contrast between shrinkage and expansion may offset a majority of the deviation from the actual intraoral environment, clients have adapted their external processes with patients to align specifically to their chosen production facility and compensate for any remaining differences allowing for efficient delivery to the patient. For example, clients may adjust their tooth grinding/preparation process and how they temporize the tooth, which is a process of putting a light cure composite plastic as a placeholder to keep the patients teeth from shifting.

The present description describes various features and components of a digital scaling factor system and methods of generating and applying digital scaling factors to scanned dental impressions to match stone models. The digital scaling factor may be applied to future impression scans to scale the digital surface model to generate a scaled digital surface model. Operations of the digital scaling factor system may be employed to scale impression scans of lab impressions relative to stone models according to particular processing identifiers applicable to the lab and a production process employed in utilization of impressions to generate dental components in order to maintain a consistent quality of dental components from production facilities to dental labs. For example, as different production facilities employ different processes, each production facility may be associated with an unique digital scaling factor. In some embodiments, the digital scaling factor system, methods, or operations thereof may be provided as a service whereby the digital scaling factor system generates a digital scaling factor for an impression source relative to a production facility and then applies the digital scaling factor to future impressions of the impression source that are to be used by the production facility in the production of dental components. In various embodiments, the systems and processes disclosed herein may be applied to allow production facilities to forgo stone modeling in the manufacture of dental products and components by utilization of the scaled surface model.

As introduced above, digital scaling factors may be generated by the digital scaling factor system that are specific to a combination of identifiers. For example, digital scaling factors may be generated for application to a particular production process, such as a production process used by a producer of dental components that utilizes the scaled digital surface model, which may include open surface models, watertight surface models, or both, in the production of dental components such as dental materials, dental appliances, or the like. The production process may include scanning technology used to generate scans from impressions, stone models, or both; design software used to generate one or more of digital surface models from impressions, stone models, or dental components from impressions, models, or digital surface models thereof; modeling stone material; stone modeling process; dental component in which the scaled digital surface model will be used to produce; or combination thereof. In any of the above or another embodiment, a digital scaling factor may be generated for particular impression materials, impression process, or both. Thus, a digital scaling factor may be generated for application in particular situations. For example, different scaling factors may be generated for application to impression scans of a first source of impressions or impression scans, such as a lab. Each scaling factor may be applicable to a particular production process, which may be further applicable to a particular impression material, impression process, or both used by the first source to generate impressions. Digital scaling factors may be generated for application to impressions or impression scans of a second source of impressions or impression scans that are similarly individually specific to production processes, impression material, impression process, or combination thereof. In one example, the digital scaling factor system may be configured to select and apply an appropriate digital scaling factor with respect to a source of the impression or impression scan and a production process the scaled digital surface model is to be applied from a plurality of digital scaling factors, each generated with respect to a specific situation, such as an applicable combination of identifiers present. In some embodiments, production processes may be specific to manufactures, which may be referred to as production facilities herein, of dental components. The digital scaling factor system may include a plurality of digital scaling factors to apply to impressions or impression scans of an impression or impression scan source wherein each of the digital scaling factors is specific to a particular production process or production facility employing the production process. Impression sources may be referred to herein as labs and may include.

In various embodiments a digital scaling factor system may be configured to generate a digital scaling factor with respect to impression scans, relative to stone model scans generated from the impression source of the impression scan, that may be applied to future impression scans to generate scaled digital surface models. The scans comprise digital surface models. The digital surface models may be open or watertight, for example. Digital surface models are computer generated representations of physical objects, which in this case include impressions and stone models produced from the impressions. Non-limiting examples of digital surface models may include an open or watertight mesh, a polysurface, a nurbs surface, or any other suitable surface model representation of digital data that may be used within the dental industry, regardless of file extension or format. The scaled digital surface models may be utilized by design programs, such as computer aided design programs, in the creation of physical or digital components used in the production of dental materials.

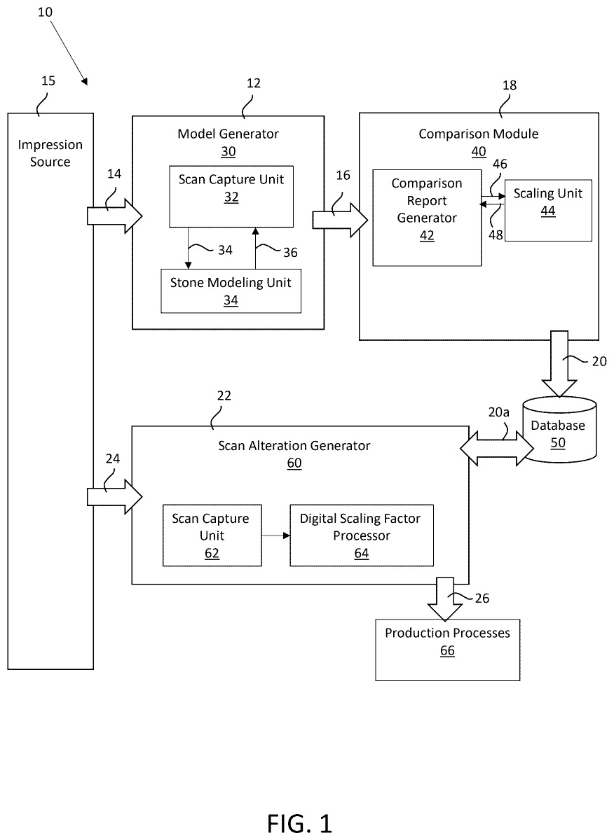

With particular reference to FIG. 1, a digital scaling factor system 10 may include or incorporate operations of one or more of a modeling system 12, comparison system 18, or scan alteration system 22. The modeling system 12 may be configured to receive, which may include selecting an impression for scanning, depicted by arrow 14, from an impression source 15. The modeling system 12 may be configured to generate digital scans of impressions, stone models, or both and provide the scans, depicted by arrow 16, to the comparison system 18 for comparison processing. The comparison system 18 may be configured to compare impression scans and stone model scans to generate a digital scaling factor. The digital scaling factor may include or be associated with data including identifiers to which it applies. The digital scaling factor and associated data may be output, indicated by arrow 20, to a database 50 for future output, indicated by arrow 20a, to a scan alteration system 22. The scan alteration system 22 may be configured to apply the digital scaling factor to an applicable impression scan to generate a scaled digital surface model 26. While FIG. 1 depicts output of the digital scaling factor to a database 50, in some embodiments the digital scaling factor may be provided directly to the scan alteration system for use. In this or another example, the scan alteration system 22 may store the digital scaling factor in the database 50, depicted by arrow 20a, for storage and later use.

The modeling system 12 may include a model generator 30 configured to generate digital scans of impressions and stone models. For example, the model generator 30 may include a scan capture unit 32 configured to scan impressions, stone models, or both. Various scanner technologies may be used, e.g., optical, radiation, wave-based, or otherwise, to generate a direct capture that drives creation of a digital surface model of the scanned object. In some embodiments, the scan capture unit 32 comprises a plurality of types of scan capture systems from which the modeling system 12 selects an appropriate type for use. The appropriate type of scan capture system may generally correspond to the end use of the digital scaling factor. For example, a digital scaling factor that will be used to scale impressions for use in production operations of a particular production facility may be generated from scans of impressions and stone models captured from the same type of scan capture system used by the production facility. In some embodiments, the model generator 30 may include or incorporate a stone modeling unit 34 to generate stone models impressions. The stone modeling unit 32 may receive impressions 34 and generate stone models 36 for scanning by the scan capture unit 32. Generating a stone model may include applying, such as pouring, a stone modeling material onto an impression to generate the stone model using the impression as negative mold. In one configuration, the stone modeling unit 34 is fully or partially automated. In this or another configuration, one or more operations of the stone modeling unit 34 may be performed manually.

According to one embodiment, the model generator 30 is configured to receive an impression from an impression source 15, depicted by arrow 14. As noted above and elsewhere herein, the impression may comprise an impression material such as polyvinyl that shrinks following impression, e.g., from the drying process. The impression may be scanned by the scan capture unit 32 to generate an impression scan. The type of capture system used to scan the impression should be the same type of capture system that will be used on the manufacturing line in the production facility to generate the digital surface model. The impression may be provided to the stone modeling unit 34, indicated by arrow 34, for production of a stone model using the impression as a negative mold. The stone model may be input into the scanner, depicted by arrow 34, to generate a scan of the stone model. The scans comprising the digital surface models of the impression and stone model may be input into the comparison system 18, depicted by arrow 36, for generation of a digital scaling factor.

In some embodiments, the digital scaling factor system 10 may additionally or alternatively receive one or more of impression scans, stone models, or stone model scans. For example, models, impressions, scans, or combination thereof may be imported into the digital scaling factor system 10 from a third party. Thus, all or a portion of the operations of the modeling system 12 may be performed by an outside source and imported into the digital scaling factor system 10, e.g., imported into the comparison system 18.

The comparison system 18 may include a comparison report generator 42 and a scaling unit 44. The comparison report generator 42 may be configured to perform a comparative analysis of an impression scan and stone model scan, such as those produced by the model generator 12. In the operations, measurable differences in dimensions of impression scans may be identified relative to scans of the stone models generated from the particular impressions that were scanned to generate the particular impression scans.

The comparison report generator 42 may output a comparison report, depicted by arrow 46, that includes comparative data derived from the comparative analysis. The comparative data may include dimensional differences between the impression scan and the stone model scan. The dimensional differences may be output in the report numerically, graphically, or both. For example, the dimensional differences may be numerically quantified with measurement values with respect to one or more identified dimensions, which may include regions, of the impression scan. Dimensional differences may be provided graphically with colors, such as in a heat map, wherein colors correspond to dimensional differences between the impression scan and the stone model scan.

The scaling unit 44 may be configured to adjust the scaling of the impression scan to align with the corresponding dimensions of the stone model to generate a digital scaling factor. This may be done in data or graphically. In one example, the scaling unit 44 is configured to utilize the comparative data provided in the comparison report to automatically scale the impression scan to align with that of the stone model scan. The comparison report generator 42 may then generate a new comparison report that includes a digital scaling factor corresponding to the scaling factor applied to the impression scan to align with the stone model scan. In one example, the scaling unit may be configured to incrementally scale the impression scan and input the incrementally scaled impression scan to the comparison report generator 42, depicted by arrow 48, to repeat the comparative analysis and provide a new or updated comparison report, arrow 46, for further scaling by the scaling unit 44. This process may be repeated on further scaling increments informed by the resulting comparison reports until the comparison report indicates alignment. For instance, the comparison data in an initial comparison report may indicate a direction, degree, or both that the impression scan differs from the stone model scan. The scaling unit 44 may apply a scale change to the impression scan in the direction toward alignment and input the scaled scan for comparative analysis. If the corresponding comparison report does not indicate alignment, the scaling unit 44 may incrementally applied in the direction needed and compared until the comparison report indicates alignment.

In one embodiment, an appropriate scaling unit is determined based on prior scaling operations, and incremental scaling includes scaling the impression scan by 1 unit followed by comparative analysis by the comparison report generator 42. If alignment is not indicated, the impression scan may be incrementally scaled by smaller or larger units by the scaling unit 44 until comparative analysis indicates alignment or overshot. For instance, in one example, the impression scan may be incrementally scaled as necessary by 1 or 2 units until the comparative analysis indicates the scaling has overshot alignment. The scale of the impression scan may then be reduced by a unit value less than, such as by half, the unit value that resulted in overshooting alignment. For example, if the previous unit value was 2, the scale of the impression scan may be reduced by 1 unit. If subsequent comparative analysis indicates alignment remains overshot, the impression scan may be incrementally reduced as necessary by a fraction of the previous unit value, e.g., 0.2 units, until comparative analysis indicates alignment. On the other hand, if the subsequent comparative analysis indicated that alignment was undershot, the impression scan may be incrementally reduced as necessary by a fraction of the previous value, e.g., 0.2 units, until comparative analysis indicates alignment. Once comparative analysis indicates alignment, the scale applied for alignment is output as the digital scaling factor for impressions corresponding to the applicable identifiers, e.g., impression source, which may include impression material, impression process, or both; type of capture system; modeling stone material; stone modeling process; or combination thereof. In one embodiment, the degree of alignment may be preset in the comparison module 40 to achieve an alignment within a maximum allowable offset. Thus, the incremental scaling process may continue until the comparative analysis indicates alignment has been achieved within the maximum allowable offset. Determination of scaling factor may be determined by manual or automated incrementation analysis described herein or by other suitable variation. In some embodiments, the comparison report generator 42 may compare one or more measurements of one or more features of a set of scans and output a scale factor or predicted scale factor based on the comparison. The scaling unit 44 may apply the scale to the scan and the comparison report generator 42 may compare one or more measurements of one or more additional features between the adjusted scale scan and stone model scan to confirm the accuracy of the scaling factor. Additionally or alternatively, the comparison report generator 42 may perform a global comparison analysis to generate a heat map or similar. In one example, incremental analysis may be further applied if the comparison does not result in alignment within a predefined allowable offset.

The scan alteration system 22 may be configured to receive impressions or impression scans and generate scaled impression scans of the impression scans by applying the appropriate digital scaling factor for the identifiers implicated by the impression and its processing and production application. The scan alteration system 22 may include a scan alteration generator 60. The scan alteration generator 60 may be configured to receive impressions, impression scans, or both, depicted by arrow 24, from an impression source 15. The scan alteration generator 22 may include a digital scaling factor processor 64 configured to receive impression scans, apply the appropriate digital scaling factor, and output a scaled surface model.

The scan alteration generator 60 may include a scan capture unit 62. The scan capture unit 62 may be similar to scan capture unit 32. The scan capture unit 62 may include one or more types of scan capture systems for selection of a scan capture system that matches that of a production facility. Impressions received from an impression source 15 may be scanned by the scan capture unit 62 using the same type of capture system that corresponds to the capture system used to generate the digital scaling factor that will be applied to scale the impression scan by the digital scaling factor processor 64. Typically, impression identifiers will be associated with an impression source 15 and the type of capture system will correspond to the capture system used by a production facility that will use the scaled impression scan in the creation of dental components. Thus, the selection of the appropriate digital scaling factor may be driven by the production facility that will be utilizing the scaled digital surface model of the impression and the associated type of scan capture system and modeling stone material used by the production facility, which may also include impression identifiers, such as the impression source or identifiers associated therewith. In some embodiments, all or a portion of the scan alteration may be provided by a production facility, such as the production facility that will be utilizing the scaled digital surface model.

In some embodiments, all or a portion of the scan alteration system 22 may be performed by a third party. For instance, a third party system may directly or indirectly request one or more digital scaling factors from the digital scaling factor system 10, e.g., from database 50, for use in scaling impression scans. The request may include identification of identifiers associated with digital scaling factors to correspond with the end use of the digital scaling factor as described herein.

In various embodiments, the scan alteration system may include or be configured to communicate with a database 50 that stores various digital scaling factors corresponding to various combinations of identifiers, such as impression identifiers, e.g., material type, processing, or both, modeling identifiers, e.g., modeling stone material, stone modeling processing, or both, and scan identifiers, such as capture system type. Accordingly, impressions or impression scans for scale processing may specify one or more applicable impression identifiers used in its creation and specify one or more modeling identifiers, scan identifiers, or combination thereof to be applied. Impression scans received may specify one or more impression identifiers used in its creation and scan identifiers associated with the scan and specify one or more modeling identifiers corresponding to the desired digital scaling factor to be applied. As noted above, identifiers may be associated with impression sources and production facilities. Thus, the database 50 may include library of digital scaling factors. The library may include a set of digital scaling factors applicable to a particular impression source for particular production facilities. As some impression sources may implement multiple impression identifiers or impression and scanning identifier combinations, a single impression source may be associated with multiple sets of digital scaling factors.

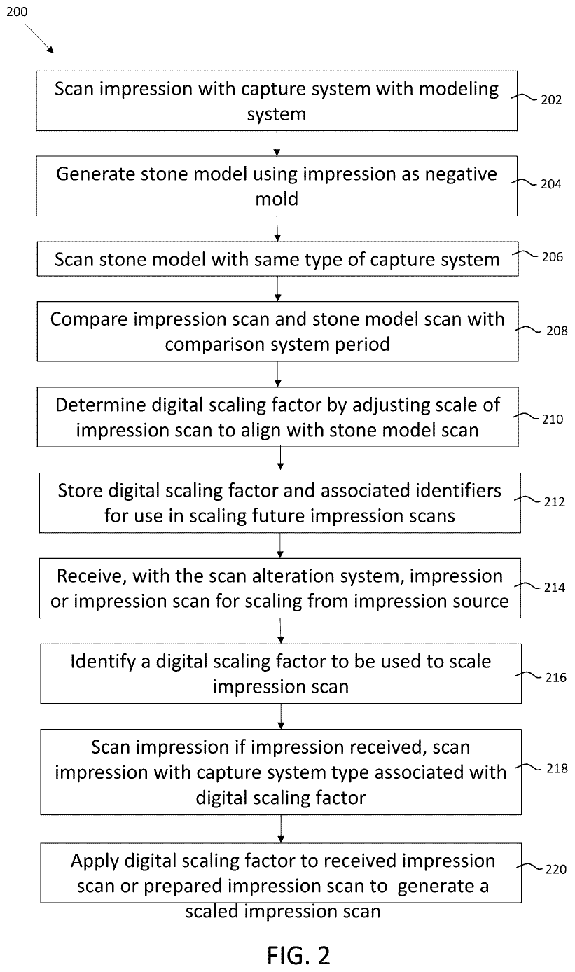

With reference to FIG. 2, a digital scaling factor determination and alteration method 200 for scaling impression scans for use in production of dental components may include scanning an impression with a capture system with modeling system 202. The modeling system may be similar to that described above with respect to FIG. 1 and elsewhere herein. The impression may be provided into the modeling system by an impression source for determination of a digital scaling factor. The impression source may be a lab or dental professional that desires to have impressions or impression scan digital models to be digitally scaled for a particular end use, such as use in particular processes to produce dental components, such as by a production facility. In some embodiments, the impression source includes the digital scaling factor system and the impressions are performed according to various impression identifiers. The impression identifiers may correspond to those of a lab or other impression source and may be matched with future impressions from one or more impression sources that the impression identifiers correspond.

The impressions utilized for generation of a digital scaling factor should comprise single tray impressions. The impressions should be full arch impressions as the larger area of comparison is necessary to generate an accurate digital scaling factor. The use of triple tray or quadrant impressions can sometimes result a comparison that appears off by only a few microns in a smaller area, but can result in deviations of 1.00 mm across a larger area such as a full arch. The type of scan capture system utilized to scan the impression may be the same type of scan capture system that will be used as part of the particular end use, such as the type of scan capture system that is used in a particular production process of a particular production facility.

Method 200 may include generating a stone model using the impression as negative mold 204. In one example, the stone model may be generated as described here, such as with respect to the stone modeling unit in FIG. 1. The stone model may be generated employing specific modeling identifiers to correspond with the modeling identifiers applicable to the end use. For example, the dental stone modeling material, stone modeling processing, or both that are used may be the same as used by a production facility that will used digital models scaled by the digital scaling factor generated by the comparison system. In some embodiments, digital scaling factors may be generated from different combinations of identifiers such that future impressions may be scanned and scaled to an end use by a digital scaling factor generated from a combination of identifiers that corresponds to the end use.

The method 200 may include scanning the stone model with same type of scan capture system 206. Using the same type of capture system used to scan the impression scan decreases variability in the scan results and their interpretation during the comparison process. Thus, it is preferrable to utilize the same type of scan capture system.

The impression scan may be compared with the stone scan using, for instance, a comparison system 208. The comparison system may be similar to that described respect to FIG. 1 or elsewhere herein. A digital scaling factor may then be determined. by adjusting the scale of impression scan to align with stone model scan 210. The digital scaling factor may be associated with the applicable identifiers for future use in scaling applicable impression scans. In some embodiments, the scaling factor and associated identifiers are stored in a database for later use in scaling the applicable impression scans 212.

In various embodiments, digital scaling factor determination of method 200 may be performed with respect to a multiple single tray impressions, such as single tray polyvinyl impressions, for a combination of identifiers. In one example, the impressions or impression scans may be selected at random or otherwise for determination of scaling factor relevant to a combination of identifiers. A scaling factor may be determined for a set of scans and applied to scan sets of the same combination for confirmation that the determined scale factor can be applied across multiple different cases and still yield acceptable results. As described herein, a library of digital scaling factors may be generated to correspond to identifiers in the production and processing of impressions. The impression scan may be associated with impression identifiers, such as those corresponding to the impression source, such as type of impression material, impression processing, or the like, which may be linked to the impression source.

Method 200 may include receiving an impression or impression scan for scaling from an impression source 214. In one example, the impression or impression scan is received by a scan alteration system similar to that described with respect to FIG. 1 or elsewhere herein. A digital scaling factor to be applied to the impression scan may be identified 216. This may include identifying the impression source and production facility and matching the impression source and production facility to a corresponding digital scaling factor in a database. In one example, identification of the digital scaling factor to apply includes comparing a scan order form that specifies the applicable identifiers to be matched to those associated with the available digital scaling factors.

If an impression was received, the impression may be scanned with a scan capture system type associated with digital scaling factor 218. For example, the same type of scan capture system used to generate the digital scaling factor may be used to scan the impression. The type of scan capture system may be specified in a scan order form. The type of scan capture system may be that which is associated with the end use.

The identified digital scaling factor may be applied to the received or prepared impression scan to generate a scaled digital surface model 220. In one example, a production facility may scan the impression with a scan capture system and the scan may thereafter be scaled by a scan alteration processor, which may be similar to that described with respect to FIG. 1 or elsewhere herein. The production facility may then utilize the scaled digital surface model in its production operations to produce dental components, e.g., according to a production request of the impression source.

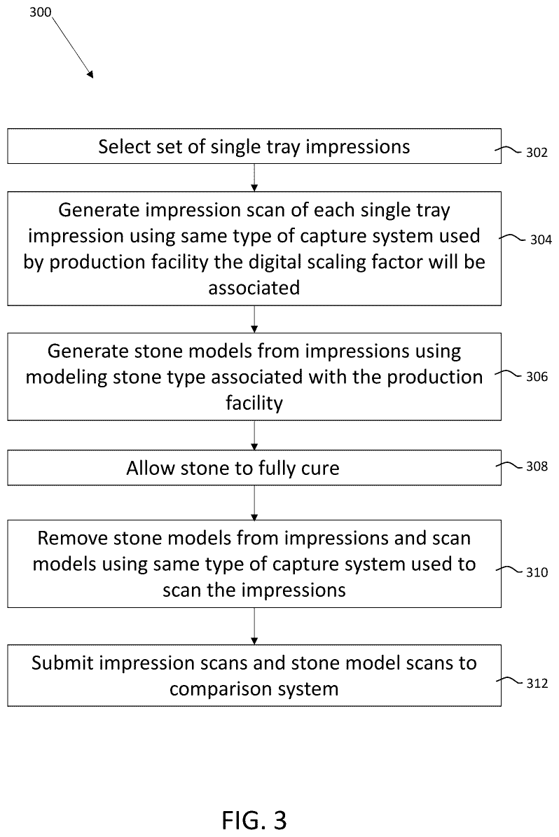

FIG. 3 illustrates a method 300 for generating impression and stone model scans for importation into a comparison system according to one embodiment. In one example, the method 300 may be applicable to generating impression and stone model scans with respect to the digital scaling factor system described herein, such as with respect to FIG. 1 or FIGS. 5-6, or method thereof, such as that described with respect to method 200 or elsewhere herein.

Method 300 may include selecting a set of single tray impressions 302. The impressions may be full arch impressions, preferably with 14 teeth on each arch. The set may include 3 single tray impressions.

Method 300 may include generating an impression scan of each single tray impression using the same type of capture system used by the production facility the digital scaling factor will be associated 304. As described above and elsewhere herein, the digital scaling factor may be associated with identifiers corresponding to a production facility, which may include the type of capture system used by the production facility to scan impressions.

Method 300 may include generating stone models from the impressions using a modeling stone type associated with the production facility 306. As described above and elsewhere herein, the digital scaling factor may be associated with identifiers corresponding to a production facility, which may include the type of dental modeling stone used by the production facility to produce stone models from impression scans. The scans of the impressions should occur prior to the impressions being poured in dental stone to prevent distortion of the impression caused by the stone pouring process from being introduced to the digital scaling factor determination process.

Method 300 may include allowing the dental modeling stone to fully cure 308. Allowing the dental modeling stone to fully cure ensures consistent expansion state of the model is scanned for use in the digital scaling factor determination process. For example, allowing the dental modeling stone to fully cure, e.g., about 5 days, may ensure that the stone has reached its full expansion factor.

Method 300 may include removing stone models from the impressions and scanning the models using same type of capture system used to scan the impressions 310.

Method 300 may include submitting the impression scans and stone model scans to a comparison system for comparative analysis and determination of digital scaling factor 312.

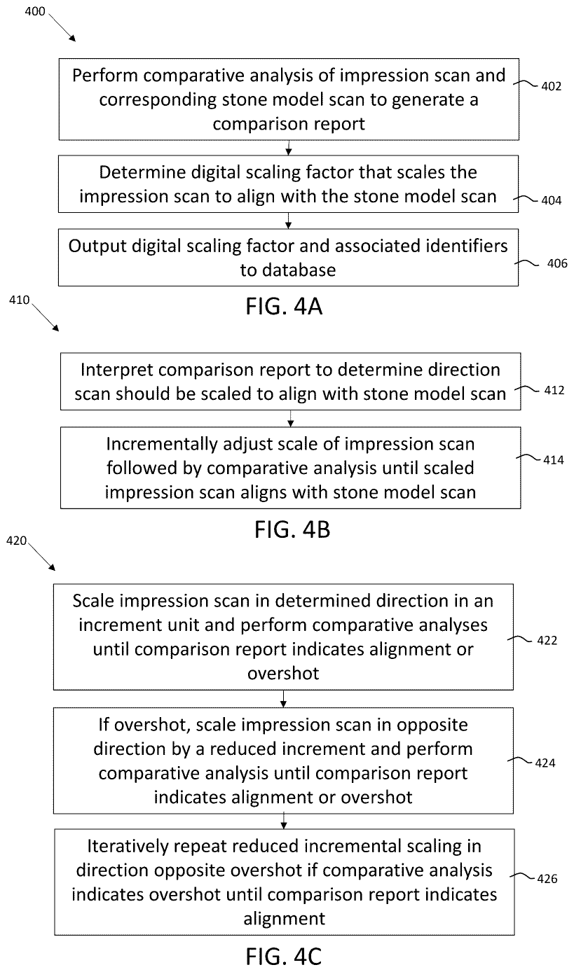

With reference to FIG. 4A, a method of generating a digital scaling factor from impression scans and stone model scans of stone models molded from impressions corresponding to the impression scans 400 may include performing comparative analysis of the impression scans and corresponding stone model scans to generate a comparison report 402.

Method 400 may include determining a digital scaling factor that scales the impression scan to align with the stone model scan 404. Method 400 may also include outputting a digital scaling factor and associated identifiers to a database 406. Additionally or alternatively, method 400 may include outputting a digital scaling factor to a scan alteration system for altering impression scans using the digital scaling factor to generate scaled surface models. In some embodiments, method 400 may be performed by the comparison system described with respect to FIG. 1 or within the digital scaling factor determination method described with respect to FIG. 2. In these or other embodiments, method 400 may be performed for a set of impressions, e.g., within method 300 described with respect to FIG. 3.

FIG. 4B illustrates a method 410 of determining a digital scaling factor that scales an impression scan to align with a corresponding stone model scan according to one embodiment. The method 410 may include interpreting a comparison report to determine a direction that an impression scan should be scaled to align with stone model scan 412. For example, the comparison report may indicate that the dimensions of the impression scan are smaller relative to the stone model scan. Thus, the direction the impression scan should be scaled is larger or to increase the dimensions. The comparison report may be provided with numerical representations, graphical representations, or both with respect to alignment or misalignment. Scaling may be automated or manually performed. Method 410 may also include incrementally adjusting the scale of the impression scan followed by comparative analysis until the scaled impression scan aligns with stone model scan 414. In some embodiments, method 410 may be performed by the comparison system described with respect to FIG. 1 or within the digital scaling factor determination method described with respect to FIG. 2. In these or other embodiments, method 410 may be performed for a set of impressions, e.g., within method 300 described with respect to FIG. 3. In an above or another embodiment, method 410 may be performed within method 400 described with respect to FIG. 4A.

FIG. 4C illustrates a method 420 of iterative incremental adjustment of a scale of an impression scan followed by comparative analysis to align the scaled impression scan with a stone model scan according to one embodiment. Method 420 may include scaling an impression scan in a determined direction in an increment unit and performing comparative analyses until comparison report indicates alignment or overshoot 422. If an overshot is returned, the method 420 may include scaling the impression in the opposite direction by a reduced increment followed by a comparative analysis until the resulting comparison report indicates alignment or overshot 424. Method 420 may further include iteratively repeating the reduced incremental scaling in a direction opposite the overshot if the comparative analysis indicates an overshot until the comparison report indicates alignment 426. For example, if the comparative analysis indicates the scans are aligned, the corresponding scaling factor is established as the digital scaling factor. If the comparison report indicates an undershot, an additional increment is applied in the direction of the previous overshot until the comparative analysis indicates that alignment is achieved or overshot. If overshot, the previous scaling increment is reduced and applied until the comparison report indicates alignment or overshot. If overshot, the process repeats with a further reduced increment. In some embodiments, method 420 may be performed by the comparison system described with respect to FIG. 1 or within the digital scaling factor determination method described with respect to FIG. 2. In these or other embodiments, method 420 may be performed for a set of impressions, e.g., within method 300 described with respect to FIG. 3. In an above or other embodiment, method 420 may be performed within method 400 described with respect to FIG. 4A, method 410 described with respect to FIG. 4B, or both.

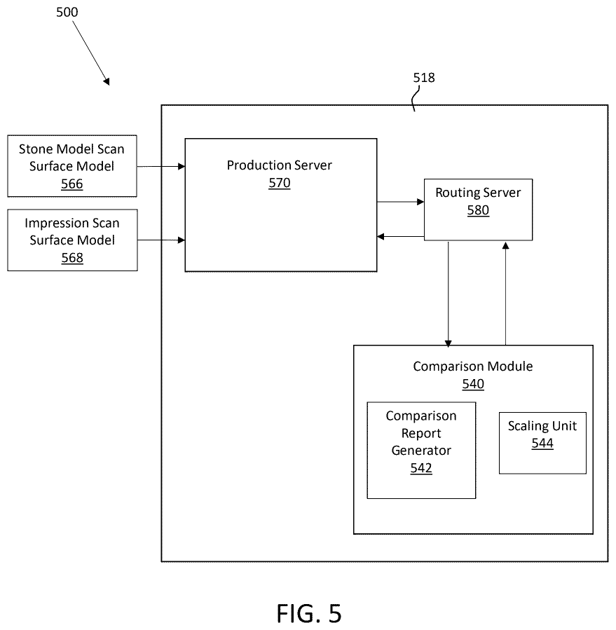

FIG. 5 schematically illustrates a comparison system 500 that executes a method of generating a digital scaling factor according to one embodiment. The system 500 and illustrated operation is described with respect to a production facility but those having skill in the art will appreciate upon reading the present description that the system and operations may be performed irrespective to a production entity. For example, the operations of the system 500 may be provided as service for impression sources with respect to particular production facilities. As another example, the system 500 may be provided by an impression source, such as a lab, for generating scaled digital surface models of impressions for inhouse production of dental components, exportation to outside production facilities, or both.

A production server 570 may receive a stone model scan 566 and an impression scan 568 for use in a digital scaling factor determination process. In one embodiment, the production facility selects multiple polyvinyl impressions to use in the determination process. For instance, three impressions may be selected. The impressions are preferably single tray impressions. The impressions are also preferably full arch impressions. The impressions may be polyvinyl impressions or impressions formed of another impression material. The impression scan 566 provided to the production server 570 may be taken of the impressions using the same type of scan capture system that will be used on a manufacturing line by the production facility to generate a digital surface model for use in production processes. This initial scan 566 is captured prior to the impression being poured in stone to prevent distortion of the impression caused by the stone pouring process from being introduced to the digital scaling factor determination process. In one embodiment, the impression scan may be captured by a scan capture unit as described with respect to FIG. 1 or elsewhere herein. For example, in one embodiment, the production server 570 is in data communication with a model generator. After the impression is scanned, the impression may be poured with the dental stone material used by the production facility in its production operations and allowed to fully cure, e.g., for 5 days, to ensure that the dental stone material has reached its full expansion factor. In one example, the stone models are poured by a stone modeling unit as described with respect to FIG. 1 or elsewhere herein. After curing, the stone models may be removed from the impressions and scanned using the same or same type of scan capture system used to scan the impression. The scans may then be submitted to a comparison system 518 including a comparison module 540. The comparison system 518 may be similar to that described with respect to FIG. 1 or elsewhere herein. For example, the comparison module 540 may include a comparison report generator 542 to compare impression scans 566 and corresponding stone model scans 568 and a scaling unit 544

In various embodiments, the production server 570 may include various production servers or servers associated with production facilities used in the operation of the comparison system 518 and receive a generated report including a digital scaling factor. FIG. 5 illustrates a flow of such a process. The stone model scans 566 and impression scans 568 may be imported into the production server 570, which may include transmitted, pushed, pulled, or otherwise. The stone model scans 566 and impression scans 568 may be exported from the production server 570 to a routing server for processing and then to a processing machine comprising the comparison module 540, which may also include transmitted, pushed, pulled, or otherwise.

The comparison report generator 542 may perform a comparative analysis of the scans to align the corresponding sets of impression and stone model scans and generate a comparison report with heat mapping that indicates degree of misalignment. The scaling unit 544 and comparison module 540 may operate as described herein to scale the impression scans to align with the corresponding stone model scans to generate a digital scaling factor, which may be included and exported as a scaling factor report including the digital scaling factor. In one example, the comparison report generator 542 may compare the scans and generate a comparison report. The scaling unit 544 may select a set of scans to scale and interpret the report to determine what direction the scan needs to be scaled. In one example, the scaling unit 544 may use a computer aided design package or similar to manually scale the scan. In one configuration, an initial scaling unit may be used to scale the impression, e.g., 0.0005, in the desired direction and the comparison report generator 542 may repeat the comparative analysis. The scaling unit 544 may repeat the scaling by a larger increment unit, e.g., 0.0010, followed by comparative analysis by the comparison report generator 542 until the comparison report indicates alignment or overshot. If overshot is indicated, the increment unit may be reduced, e.g., to 0.00005, in the opposite direction for each comparison until alignment or overshot is indicated. If overshot is indicated, the increment unit may be further reduced, e.g., to 0.0001, in the opposite direction in each comparison until alignment or overshot is indicated. This process may be repeated until the desired degree of alignment is achieved and the scale factor is considered established once the report indicates alignment between the scaled impression scan and the stone model scan.

The complete report may also include one or more applicable identifiers described herein. In another example, the applicable identifiers are added or otherwise associated with the scaling factor report or digital scaling factor thereof by the production server 570 or otherwise. The scaling factor report may be transmitted, pushed, pulled, or otherwise provided to the routing server 580. In some embodiments, the production server 570 continuously scans the routing server 580 for scaling factor reports including digital scaling factors for a production facility that it is associated with and then pulls the appropriate scaling factor report into the production server 570 for use in production processing. Thus, in some embodiments, the comparison module 540 may perform comparison analyses to determine digital scaling factors for multiple production facility clients. In one embodiment, the comparison module 540 or routing server 580 automatically transmits scaling factor reports to associated production servers 570, e.g., using an address, end point identifier, or other address or identifier corresponding to the production facility recipient the complete report should be sent. It will be appreciated that in some embodiments, the comparison module 540 may be provided on or in direct communication with the production server 570. In some embodiments, the scaling factor report or digital scaling factor thereof may be provided into a database for future reference and application to scale impression scans.

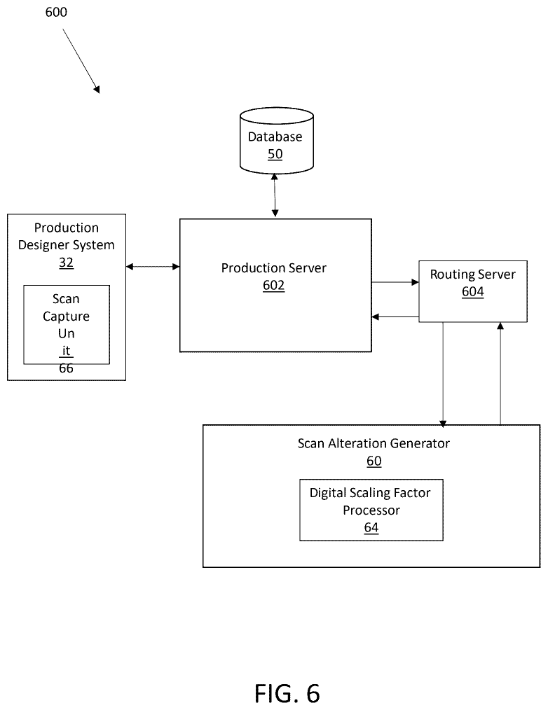

FIG. 6 schematically illustrates an embodiment of a scan alteration system 600 that executes a method of scaling impression scans by applying a digital scaling factor to generate a scaled surface model for use in production of dental components. A production server 602, which may comprise a server of a production facility or a server involved in providing a scaling service, may receive an scaling order from a production designer system 32. The production designer system 32 may comprise one or more of an impression source, lab, production facility, or production designer or scanning software. In one example, an impression may be provided to the production designer system 32 by an impression source comprising a lab and the production designer system 32 comprises a production facility that will utilize the scaled surface model in the production of dental components. The scaling order may identify an impression source, lab, production facility or other identifiers that may be used to match the scaling order to the appropriate scaling factor report.

The production server 602 may access a database 50 including scaling factor reports generated from digital scaling factor determination processes as described herein. The scaling factor reports may be associated with impression sources, identifiers used in its scaling factor determination process, production facility, or other identifiers, such as those described herein. The production server 602 may access the scaling factor reports on demand, e.g., when a scaling order having matching identifiers is received, or may access multiple scaling factor reports and maintain such reports in a working file until needed. In one example, the impression sources may be registered with the production server 602 and be associated with settings including scaling factor reports. Thus, scaling orders may identify an impression source, such as a lab. The product facility server 602 may maintain scaling factor reports for registered impression sources.

In some embodiments, scaling orders may include impression scans to be scaled, and the production designer system 32 may include or communicate with a scan capture unit 66 to obtain impression scans for scaling. In a further or another embodiment, an impression source may provide impression scans to the production designer system 32 or the production designer system may request impression scans from the scan capture unit 66. In a further or another embodiment, the production server 602 may request scans from a scan capture unit 66 as specified or determined appropriate via identifiers in the scaling order, which may include the type of scan capture system used. For example, the scaling order may identify a production facility that will use the scaled surface model and the production server 602 may match the production facility or the appropriate identifiers corresponding to the production facility with a scaling factor report that specifies the type of scan capture system to be used to scan the impression, which will generally correspond to the type of scan capture system used by the production facility and in the determination of the digital scaling factor.

As described above and elsewhere herein, the production server 602 may match scaling order identifiers to identifiers associated with scaling factor reports to identify an appropriate scaling factor report to associate with the scaling order. The production server 602 may associate identifiers with impression scans such as information about the dental design software used by the production designer system 32 or other end use application. Identifiers will typically be specified in or determined by analysis of the scaling order. Information about dental design software used by the production designer system 32 or other end use application may include factors such as case number within the production designer system 32 to which the scans correspond, which jaw part (upper or lower) the scan represents, what cleanup or processing macro to use when processing the scan in order to apply the correct instructions, or which production facility to return the scan or production facility of origin. For example, the production facility the scans are to be returned, typically the production facility of origin, is used in determining the correct scaling factor to be applied. The identifiers may be provided in the scaling order, scaling factor report, or both. The identifiers may be associated with impression scans in various ways. For example, impression scans for scaling may be provided in scan files named to identify particular identifiers that the scan alteration generator 60 or digital scaling factor processor 64 may use to properly process the impression scan. In one example, the applicable digital scaling factor is embedded in the scan file. In this or another example, identifiers are incorporated as part of the file name. For example, the digital scaling factor may be embedded in the scan file and identifiers may be incorporated into the name of the file. The identifiers may also be used for routing the order components, which may include associating the scaled surface model with the scaling order for output to the production designer system 66. In one example, impression scans, e.g., scan files, are moved to a routing server 604 and held in a queue for retrieval by the scan alteration generator 60. For example, a program running on the scan alteration generator 60 may pull the next impression scan, e.g., scan file, from the queue.

The scan alteration generator 60 may be configured as described above and elsewhere herein. For example, impression scans may be scaled by a digital scaling factor processor 64 according to a digital scaling factor specified by a scaling factor report. As noted above, the appropriate digital scaling factor to be used to scale an image scan may be associated, e.g., embedded, with the image scan by the production server 602. For example, the scan alteration generator 60 may read the file name associated with scans to determine how to process the image scan. For instance, scans labeled as impression scans or otherwise associated with impression scan identifier, the scan may be analyzed to extract the scale factor previously embedded in it in the process for the appropriate scale factor information, which is passed to the digital scaling factor processor 64, which may include a computer aided design software package, to be used as a variable to be called during the scaling process. In one example, a scale factor is embedded in a scan file by adding the scale factor as a text string into the file information itself, e.g., into the file information of an STL file, without corrupting the scan data, as part of an XML style container. The scan alteration generator 60 may then read the file as a text file and extract the tagged information and pass it to the digital scaling factor processor 64 doing the scaling.

After scaling the impression scan to generate the scaled surface model, the scan alteration generator 60 may route or otherwise transmit the scaled impression scan back to the production server 602. In one embodiment, the alteration generator 60 pushes the scaled impression scan to the routing server 604 and the production server 602 pulls the scaled impression scan from the routing server 604. In one example, the routing server may serve multiple production servers 602 and the production server 602 will pull or receive scaled impression scans labeled, e.g., in a file name, for the production server 602 or its associated production facilities or scan orders. In one embodiment, the file name of the scaled impression scan is interpreted by the production server 602 and is merged back into the scan order or production designer system 32 for continuation of the production process utilizing the scaled surface model.

In some embodiments, identifiers accompanying a scan order may specify particular identifiers such as impression, modeling, scan, production, or other identifiers that the production server 602 or scan alteration system 22 may use to match with identifiers associated with scaling factor reports to identify the appropriate scaling factor report to associate with the impression scan or impression, which may also be used to direct the appropriate type of scan capture system to use to scan the impression. Identifiers accompanying a scan order may identify impression identifiers used to create the impression and type of scan capture system used to create the impression scan or that should be used to create an impression scan. The identifiers may further specify modeling identifiers or production processing identifiers. In one example, the type of scan capture system that was or should be used to create the impression scan is determined from identification of the destination production facility, which may correspond to an origin production facility if the scaling order is received from or otherwise originated from a particular production facility, such that the identification of the destination production facility specifies the type of scan capture system to be used to create the impression scan and that was used in the digital scaling factor determination process for purposes of identification of the appropriate scaling factor report.

In one embodiment, the production server 602 or scan alteration system 22 (see FIG. 1) receives an impression scan with accompanying identifiers that specify processing aspects for the impression scan. For example, an impression scan may identify an impression source, which may include a lab. The impression source may be associated with one or more digital scaling factor reports. The identifiers may identify a production facility that will utilize the scaled surface model. The production server 602 or scan alteration system 22 may use the impression source and destination production facility to identify the appropriate digital scaling factor report and embed or otherwise associate the digital scaling factor or report thereof with the impression scan by matching the identified impression source with the identified production facility. As described above, the impression source, production facility, or both may be associated with various impression, modeling, scan, production, or other identifiers used in the digital scaling factor determination process. If the impression order relates to an impression that has not been scanned, the production server 602 or scan alteration system 22 may initiate or otherwise order a scan of the impression with the appropriate type of scan capture system specified by the identifiers or scaling factor report.

It is to be appreciated that modifications to the components and process flows of scan alteration system 602 shown in FIG. 6 may be modified and operations described with respect to one or more components may be executed by one or more other components or be distributed among multiple components. For example, in one embodiment, the scan alteration system 602 excludes the production designer system 66, routing server 604, or both. In one embodiment, the scan alteration generator 60 may perform the operations of the production server 602. In some embodiments, digital scaling factor determination, application of digital scaling factor to impressions scans, or both are provided as a service. For example, an impression source, lab, or production facility may submit requests to the appropriate systems or system components described herein for determination of a digital scaling factors, generation of scaled digital surface models from impression scans, or both. Those having skill in the art will appreciate that the teachings with respect to the systems and methods described herein may be modified. For example, in one embodiment, an impression scan may be compared with an intraoral scan of a patient the impression subject to the scan was prepared from to get an accurate scaling for impressions relative to actual intraoral environment.

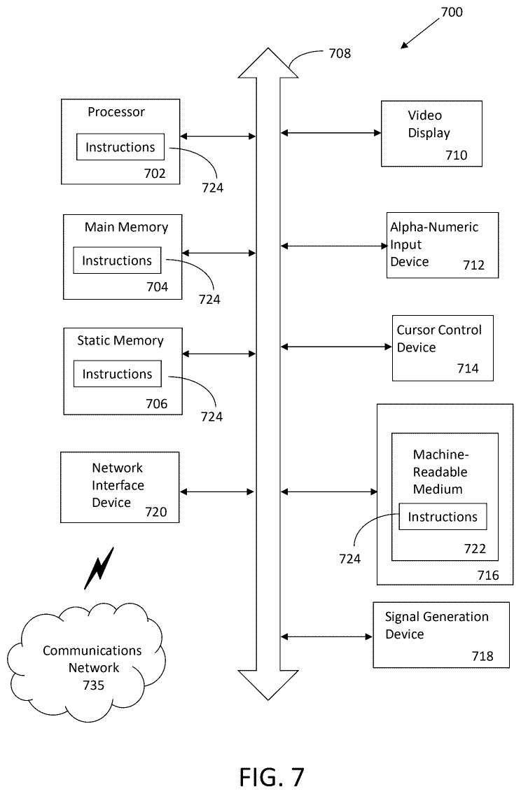

Referring now also to FIG. 7, at least a portion of the methodologies and techniques described with respect to the exemplary embodiments of the system 10, which may include systems 500 and 600, can incorporate a machine, such as, but not limited to, computer system 700, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10. As another example, the computer system 700 may assist with generating impression scans, stone models, stone model scans, comparative analysis, scale determination, order processing, routing, report generation, identifier identification, identifier association, matching identifiers, impression scan scaling, or a combination thereof.

In some embodiments, the machine may operate as a standalone device. In some embodiments, the machine may be connected to and assist with operations performed by other machines and systems, such as, but not limited to, any functionality, generator, adjuster, mapping tool, model, engine, executor, or other functionality described herein, any of which may be provided by such other machines or systems to the machine for use by system 10 in performance of the operations described herein. The machine may be connected with any component in the system 10. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710, which may be, but is not limited to, a liquid crystal display (LCD), a flat panel, a solid state display, or a cathode ray tube (CRT). The computer system 700 may include an input device 712, such as, but not limited to, a keyboard, a cursor control device 714, such as, but not limited to, a mouse, a disk drive unit 716, a signal generation device 718, such as, but not limited to, a speaker or remote control, and a network interface device 720.

The disk drive unit 716 may include a machine-readable medium 722 on which is stored one or more sets of instructions 724, such as, but not limited to, software embodying any one or more of the methodologies or functions described herein, including those methods illustrated above. The instructions 724 may also reside, completely or at least partially, within the main memory 704, the static memory 706, or within the processor 702, or a combination thereof, during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 722 containing instructions 724 so that a device connected to the communications network 735, another network, or a combination thereof, can send or receive voice, video or data, and communicate over the communications network 735, another network, or a combination thereof, using the instructions. The instructions 724 may further be transmitted or received over the communications network 735, another network, or a combination thereof, via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A digital scaling factor system for determining an impression scan digital scaling factor and scaling impression scans to generate scaled surface models for use in dental component production, the system comprising:
a model generator comprising a scan capture unit and a stone modeling unit, wherein the scan capture unit is configured to generate an impression scan by scanning a polyvinyl impression using a scan capture system, and a stone modeling unit configured to generate a stone model using the polyvinyl impression as a negative mold, and wherein the scan capture unit is further configured to generate a stone model scan by scanning the stone model after curing using a same type of scan capture system that was used to scan the impression;
a comparison module configured to perform a comparative analysis of the impression scan and stone model scan and determine a digital scaling factor that scales the impression scan to align with the stone model scan;
a scan alteration system configured to receive an impression scan for scaling that was generated from a polyvinyl impression and select a digital scaling factor that would align the impression scan for scaling with a stone model scan of a stone model that would be generated from the polyvinyl impression that was scanned to generate the impression scan for scaling if utilizing an identified type of scan capture system and stone modeling process, wherein the scan alteration system includes a scan alteration generator including a digital scaling factor processor configured to scale the impression scan for scaling by the selected digital scaling factor to generate a scaled surface model.

2. The system of claim 1, wherein the impression scan for scaling is associated with an impression source.

3. The system of claim 2, wherein the scan alteration system is configured to receive a production facility identifier with the impression scan for scaling and use the impression source and production facility identifier to identify the digital scaling factor that scales the impression scan to dimensions of a stone model if generated from the impression using scanning and stone modeling processes of the production facility.

4. The system of claim 1, wherein the scan alteration system further includes or receives scans from a scan capture unit and is configured to use the scan capture unit to scan polyvinyl impressions for scaling of impression scans generated from the polyvinyl impressions for scaling, wherein the scan alteration generator is configured to select a digital scaling factor that would align the impression scan of the polyvinyl impression for scaling with a stone model scan of a stone model generated using the polyvinyl impression for scaling as a negative mold if utilizing an identified type of scan capture system and stone modeling process, and wherein the digital scaling factor processor is configured to scale the impression scan of the polyvinyl impression for scaling by the selected digital scaling factor to generate a scaled surface model.

5. The system of claim 1, wherein the model generator is configured to select multiple single tray full arch polyvinyl impressions, scan the polyvinyl impressions, generate stone models from the impressions, and scan the stone models.

6. The system of claim 1, wherein the comparison module comprises a comparison report generator and a scaling unit, wherein the comparison report generator is configured to compare the impression scan and stone model scan and output a comparison report depicting misalignment between the impression scan and the stone model scan, and wherein the scaling unit is configured to interpret the comparison report and scale the impression to align with the stone model scan.

7. The system of claim 6, wherein the scaling unit is configured to interpret the comparison report to determine direction the impression scan should be scaled to align with stone model scan.

8. The system of claim 7, wherein the comparison report includes a heat map that depicts the misalignment.

9. The system of claim 7, wherein the scaling unit is configured to apply an incremental scaling adjustment to the impression scan and the comparison report generator is configured to perform the comparative analysis after each incremental adjustment until the comparison report generator generates a comparison report that indicates alignment between the scaled impression scan and stone model scan.

10. The system of claim 7, wherein the scaling unit is configured to determine a direction of scaling adjustment based on the interpretation of the comparison report, wherein the scaling unit is configured to apply an incremental scale adjustment to the impression scan in the direction followed by comparative analysis by the comparison report generator after each incremental scale adjustment until a comparison report indicates alignment or overshot, wherein if the comparison report indicates overshot, the scaling unit and comparison report generator are configured to iteratively repeat application of an incremental scale adjustment, reduced relative to the incremental scale adjustment previously applied that resulted in the overshot, to the impression scan in a direction opposite of the direction previous that resulted in the overshot, followed by comparative analysis until a comparison report indicates alignment.

11. A method, the method comprising:
determining an impression scan digital scaling factor comprising:
generating an impression scan comprising scanning with a scan capture unit a polyvinyl impression using a scan capture system;
generating a stone model using the polyvinyl impression as a negative mold;
generating a stone model scan comprising scanning the stone model after curing using a same type of scan capture system that was used to scan the impression;
performing a comparative analysis of the impression scan and stone model scan; and
determining a digital scaling factor that scales the impression scan to align with the stone model scan; and
scaling an impression scan to generate scaled surface models for use in dental component production comprising:
receiving an impression scan for scaling that was generated from a polyvinyl impression;
selecting a digital scaling factor that aligns the impression scan for scaling with a stone model scan of a stone model that would be generated from the polyvinyl impression that was scanned to generate the impression scan for scaling if utilizing an identified type of scan capture system and stone modeling process,
scaling, with a digital scaling factor processor, the impression scan for scaling by the selected digital scaling factor to generate a scaled surface model.

12. The method of claim 11, wherein the impression scan for scaling is associated with an impression source.

13. The method of claim 12, further comprising receiving a production facility identifier with the impression scan for scaling and using the impression source and production facility identifier to identify the digital scaling factor that scales the impression scan to dimensions of a stone model if generated from the impression using scanning and stone modeling processes of the production facility.

14. The method of claim 11, further comprising:
receiving scans from a scan capture unit and using the scan capture unit to scan polyvinyl impressions for scaling of impression scans generated from the polyvinyl impressions for scaling; and
selecting a digital scaling factor that would align the impression scan of the polyvinyl impression for scaling with a stone model scan of a stone model generated using the polyvinyl impression for scaling as a negative mold if utilizing an identified type of scan capture system and stone modeling process, and wherein the digital scaling factor processor is configured to scale the impression scan of the polyvinyl impression for scaling by the selected digital scaling factor to generate the scaled surface model.

15. The method of claim 11, wherein performing a comparative analysis of the impression scan and stone model scan comprises comparing, with a comparison report generator, the impression scan and stone model scan and outputting a comparison report depicting misalignment between the impression scan and the stone model scan, and wherein determining a digital scaling factor that scales the impression scan to align with the stone model scan comprises interpreting, with a scaling unit, the comparison report and scaling the impression to align with the stone model scan.

16. The method of claim 15, wherein the scaling unit interprets the comparison report to determine direction the impression scan should be scaled to align with stone model scan.

17. The system of claim 16, wherein the comparison report includes a heat map that depicts the misalignment.

18. The method of claim 16, wherein the scaling unit is configured to apply an incremental scaling adjustment to the impression scan and the comparison report generator is configured to perform the comparative analysis after each incremental adjustment until the comparison report generator generates a comparison report that indicates alignment between the scaled impression scan and stone model scan.

19. The method of claim 16, wherein the scaling unit is configured to determine a direction of scaling adjustment based on the interpretation of the comparison report, wherein the scaling unit is configured to apply an incremental scale adjustment to the impression scan in the direction followed by comparative analysis by the comparison report generator after each incremental scale adjustment until a comparison report indicates alignment or overshot, wherein if the comparison report indicates overshot, the scaling unit and comparison report generator are configured to iteratively repeat application of an incremental scale adjustment, reduced relative to the incremental scale adjustment previously applied that resulted in the overshot, to the impression scan in a direction opposite of the direction previous that resulted in the overshot, followed by comparative analysis until a comparison report indicates alignment.
